(19) United States
(12) Patent Application Publication
(10) Pub. No.: US 2011/0047707 A1
(43) Pub. Date: Mar. 3, 2011

(54) SURFACE IMPRESSION REMOVAL TECHNOLOGY SYSTEM

(76) Inventor: Mark J. Hobson, Greensboro, NC (US)

(21) Appl. No.: 12/552,657

(22) Filed: Sep. 2, 2009

(51) Int. Cl. A47C 27/14; B68G 5/00

(52) U.S. Cl. 5/691

(57) ABSTRACT

The Surface Impression Removal Technology System of the present invention and related disclosure includes at least one foam pad that is placed between a rigid, semi-rigid or sprung foundation surface and beneath a support structure in order to boost the support, profile and feel characteristics of a fully assembled support device, such as a mattress. The foam conforms to the contours of the mattress or support device and eliminates any hard edges or transition ridges between the pad and the mattress. The surface impression removal pads can possess a variety of characteristics that define the qualities desired by the user. The pads can also be positioned in several different arrangements to facilitate, for example, dual comfort zones.

### RELATED APPLICATIONS

There are no applications related to this application.

### FIELD OF THE INVENTION

The present invention relates to mattresses and more specifically, to a foam pad or pads placed beneath an existing fully assembled mattress to boost the support profile and feel characteristics of the mattress.

### BACKGROUND OF THE INVENTION

Mattresses become worn over a period of time. Upholstery layers tend to compress and may lose some of their support characteristics, leading to surface impressions upon the sleep surface. The original feel of the mattress deteriorates and can also appear to have hills and valleys that both decrease the comfort level and reduce the aesthetic appeal of the mattress.

Several pieces of related art have presented different ways to correct worn mattresses. For example, U.S. Pat. No. 4,745,645 and U.S. Pat. No. 6,665,898 teach the use of inflatable air bladders inserted between a box spring and a worn mattress. However, this concept requires the complicated and expensive use of a collection of air bladders, pumps, hoses, valves and control mechanisms. Also, the use of air bladders may cause uneven support or the air bladders themselves may develop leaks.

A mechanical expansion device is disclosed in U.S. Pat. No. 2,543,310. The device is placed between a mattress and a box spring and is adjusted by a crank handle. This device is expensive to manufacture and does not address mattress sagging or loss of firmness on the mattress surface.

U.S. Pat. No. 6,871,369 teaches the use of a three-part kit containing paraboloid-shaped foam inserts of varying thickness and base size inserted between the box spring and mattress or placed directly on top of a sagging mattress. This method is also lacking due to the extra cost of crafting paraboloid materials and the difficulty of correctly positioning up to three separate inserts.

There remains a need in the art for a simple, cost-effective way to correct the effects of a worn mattress and restore a mattress surface to its desired comfort.

### SUMMARY OF THE INVENTION

The Surface Impression Removal Technology System of the present invention and related disclosure includes at least one surface impression removal pad that is placed beneath a support device, such as a mattress, and above a rigid base, such as a mattress foundation, to boost the support, profile and feel characteristics of a fully assembled support device. In one embodiment, two surface impression removal pads are positioned in a side-by-side arrangement to create a dual comfort zone. In another embodiment two surface impression removal pads are positioned in a head-to-toe arrangement. An in yet another embodiment, two surface impression removal pads are stacked atop each other. The foam pads may possess different characteristics, such as material, density, ILD and thickness, and may be customized to produce the support qualities desired by the user.

### DESCRIPTION OF THE DRAWINGS

FIG. 1 is a drawing of the surface impression removal pad of the present invention in placed between a box spring and a mattress.

FIG. 2 is a cross-sectional view of the box spring, surface impression removal pad and mattress of FIG. 1.

FIG. 3 is a drawing of two surface impression removal pads placed in a side-by-side configuration between a box spring and a mattress.

FIG. 4 is a cross-sectional view of the two surface impression removal pads, box spring and mattress of FIG. 3.

FIG. 5 is a drawing of two surface impression removal pads placed in a head-to-toe configuration between a box spring and a mattress.

FIG. 6 is a cross-sectional view of the two surface impression removal pads, box spring and mattress of FIG. 5.

FIG. 7 is a drawing of two surface impression removal pads placed in a stacked arrangement between a box spring and a mattress.

FIG. 8 is a cross-sectional view of the two surface impression removal pads, box spring and mattress of FIG. 7.

### DETAILED DESCRIPTION OF PREFERRED AND ALTERNATE EMBODIMENTS

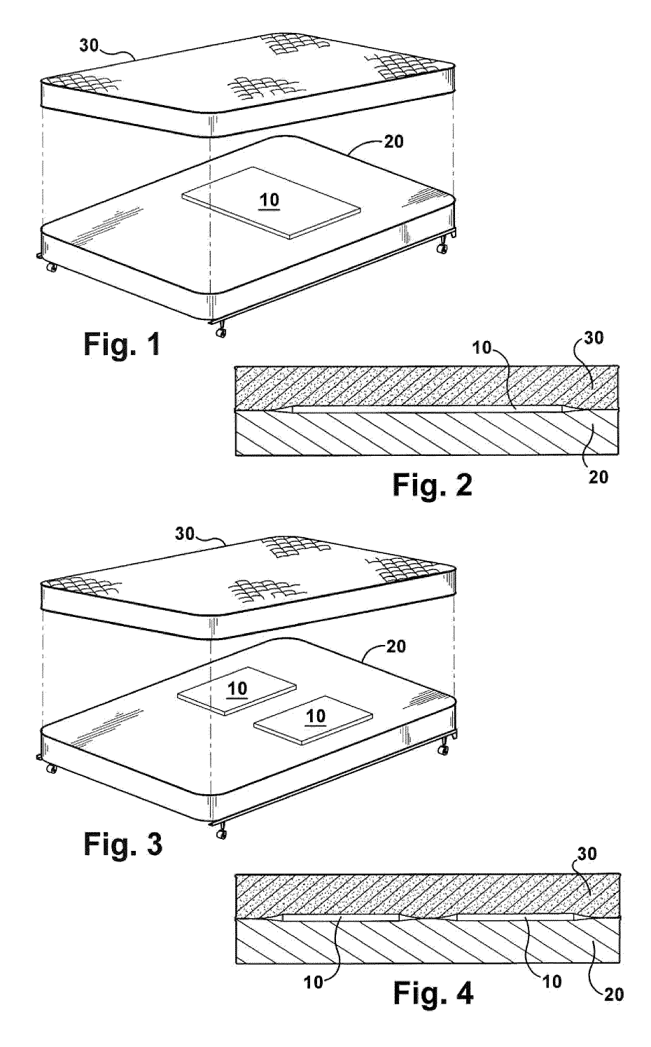

The Surface Impression Removal Technology System of the present invention and related disclosure is primarily used to boost the support, profile and feel characteristics of a fully assembled support device, such as a worn mattress, by placing an appropriately sized surface impression removal pad 10 beneath the support device 30, on top of a solid base structure 20 and away from the perimeter of the worn support device 30 and base structure 20, as shown in FIGS. 1 and 2. As used herein the term “support device” includes but is not limited to mattresses, cushions for sofas, sleeper sofas, recliners and chairs. The term “solid base structure” includes, but is not limited to, a mattress foundation, sofa foundation, chair foundation or any substantially flat, rigid, semi-rigid or sprung surface. The surface impression removal pad may also be referred to as “support booster”, “support pad” or “the pad”.

Variations in the type of foam, the initial load deflection (ILD), density, shape and thickness of the pad create differentiation in feel, profile and support characteristics that can be perceived at the surface of the mattress by a user. This allows for a high level of customization based on the mattress qualities desired by the user. For example, dual comfort zones can be made in the case wherein a person sleeping on one side of a mattress surface may desire an extremely firm mattress feel while the person sleeping on the other side of the mattress surface may desire a less firm or softer mattress surface. This configuration is shown in FIGS. 3 and 4. One surface impression removal pad 10 made of a particular foam with a particular ILD, density, shape and thickness can be placed under the right side of the mattress 30 and a second surface impression removal pad 10 made of the same or alternate foam having an alternate ILD, density, shape and thickness can be placed under the left side of the mattress 30 so that each user may individually realize their desired mattress qualities. Not only is the surface impression removal pad 10 flexible in terms of differing support and feel characteristics, but it is also flexible in terms of the duration of the desired mattress effects. The surface impression removal pad or pads 10 may simply be placed beneath a mattress 30 on a temporary basis, allowing for easy removal and replacement. Alternately, the selected surface impression removal pad or pads 10 may be placed inside a mattress 30 for a more permanent arrangement. In this case, the pad 10 would be placed directly above the base fabric or non-skid panel on the inside as the mattress is being assembled. The internal support system, either an innerspring with foam base or solid/laminated foam core, would sit directly on top of the pad 10. The entire mattress (with pad built inside) would sit on a base support 20 or mattress foundation.

The surface impression removal pad of the present invention is generally rectangular in shape with a generally planar top and bottom surface. Four generally planar side surfaces with uniform thickness extend between the generally planar top and bottom surfaces of the pad. The length, width and thickness of the support pad 10 must be sufficiently smaller than the length, width and thickness of the mattress 30, so that the mattress 30 is able to conform around the pad 10 and the pad may thus translate its support and profile properties through to the surface of the mattress 30. Surprisingly, with the proper foam, hardness and density selection, the foam pad, having uniform thickness, will conform to the mattress 30, making any hard edges or transition ridges between the pad 10 and mattress 30 undetectable by the user.

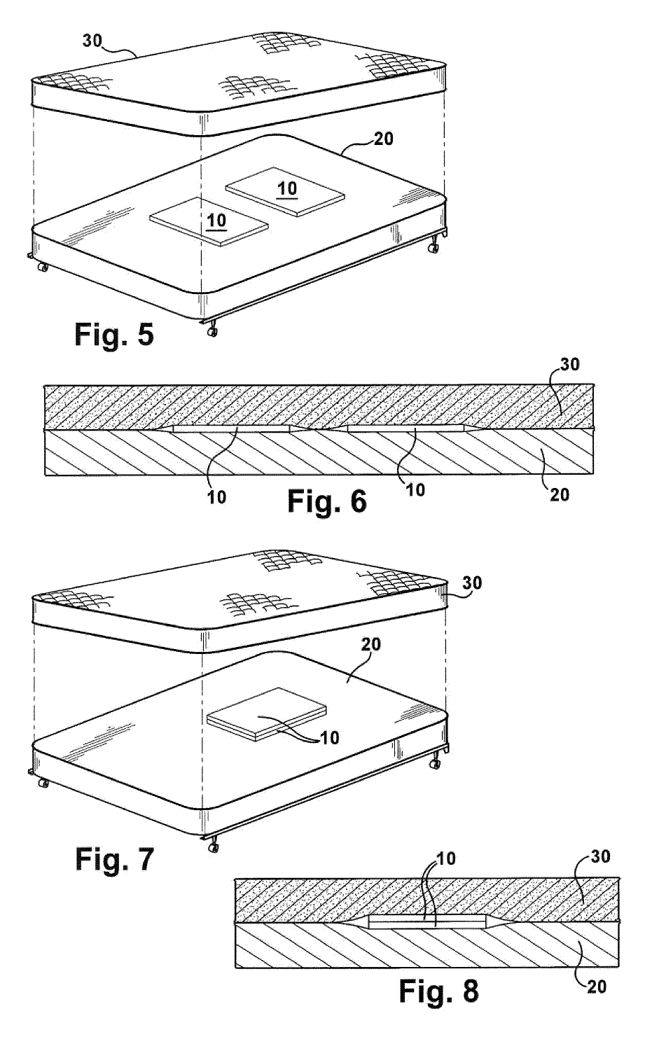

In addition to the dual comfort arrangement, described above, whereby two surface impression removal pads 10 of differing characteristics are placed in a side-by-side arrangement (shown in FIGS. 3 and 4), two of the same or differing surface impression removal pads 10 may be placed in a head-to-toe arrangement to accommodate one sleeper with elongated impact support at the mattress surface, as shown in FIGS. 5 and 6. Another arrangement, shown in FIGS. 7 and 8, includes placing two support pads 10 atop one another or in a double-stacked position for extra profile. Other such configurations are considered within the scope of this application.

A preferred embodiment of the surface impression removal pad 10 of the present invention and related disclosure is a visco-elastic memory foam pad being approximately between 1.5 and 2 inches thick, having a density of 2.5 lb/ft3 and an ILD of 12. This embodiment functions best to elevate the profile of a mattress surface above where it is placed, and to regain lost support in mattresses that have been used sufficiently to create a sleep surface impression, albeit one that is less than the typical warrantable depth required by most major mattress manufacturers (i.e., less than the typical 1.5-inch depth considered to be a warrantable mattress impression). Other memory foam variations were tested having varying degrees of density and indentation force deflection (IFD) and may be used as potential options for users selecting a pad based on a distinct desired feel and level of firmness. Other foam options include, but are not limited to, latex, polyurethane, convoluted polyurethane, polyethylene, and combinations thereof. Foam densities may vary from approximately 1.1 lb/f³ to approximately 4.56 lb/f³. IFD measurements may range from approximately 12 to approximately 70. ILD measurements may range from approximately 10 to approximately 85. Thickness measurements may vary from approximately 1 inch to approximately 2 inches or greater depending on the material selected and the desired effect.

In order to obtain the proper benefits of the support booster pad, it must be placed beneath the mattress and on a substantially solid base or foundation so it is out of sight and so the mattress can conform around the pad in place and translate the pad characteristics up to the surface of the mattress. The pad must not be placed too close to a side edge or perimeter of the mattress and should not be visible from the side of the mattress, otherwise the mattress will not wrap around the pads properly and the support pad will not function as desired. Also, as discussed above the pad must be sufficiently smaller than the mattress to allow the mattress to conform around the pad.

While the support booster pad of the present invention has been explained and discussed in terms of use in conjunction with a previously assembled mattress, similar surface impression removal pads of smaller size may also be used for placement under upholstered seat cushions of sofas, sleep sofas, recliners, chairs, etc. to also change the support, feel and profile characteristics when seated on such cushions.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A Surface Impression Removal Technology System comprising:
at least one foam pad having a generally planar top surface, a generally planar bottom surface, and four generally planar side surfaces with uniform thickness;
wherein the at least one foam pad is placed underneath a support device and atop a base structure; and
wherein the at least one foam pad has length, width and thickness measurements that are less than the length, width and thickness measurements of the support device.

2. The Surface Impression Removal Technology System of claim 1, wherein the at least one foam pad is made of visco-elastic foam.

3. The Surface Impression Removal Technology System of claim 1, wherein the at least one foam pad is approximately between 1.5 and 2 inches thick.

4. The Surface Impression Removal Technology System of claim 1, wherein the at least one foam pad has a density of approximately 2.5 lb/ft³.

5. The Surface Impression Removal Technology System of claim 1, wherein the at least one foam pad has an ILD of 12.

6. The Surface Impression Removal Technology System of claim 1, wherein the preassembled support device is a bed mattress.

7. The Surface Impression Removal Technology System of claim 6, wherein a first foam pad is positioned in a side-by-side arrangement with a second foam pad, both foam pads being underneath the mattress and above the mattress foundation.

8. The Surface Impression Removal Technology System of claim 7, wherein the first foam pad has a density that is different from the density of the second foam pad.

9. The Surface Impression Removal Technology System of claim 7, wherein the first foam pad has an ILD that is different from the ILD of the second foam pad.

10. The Surface Impression Removal Technology System of claim 7, wherein the first foam pad has a different thickness than the second foam pad.

11. The Surface Impression Removal Technology System of claim 6, wherein a first foam pad is placed in a head-to-toe arrangement with a second foam pad, both foam pads being underneath the mattress and atop of the mattress foundation.

12. The Surface Impression Removal Technology System of claim 11, wherein the first foam pad has a different density than the second foam pad.

13. The Surface Impression Removal Technology System of claim 11, wherein the first foam pad has a different ILD than the second foam pad.

14. The Surface Impression Removal Technology System of claim 11, wherein the first foam pad has a different thickness than the second foam pad.

15. The Surface Impression Removal Technology System of claim 6, wherein a first foam pad is position directly atop a second foam pad, both foam pads being underneath the mattress and above the mattress foundation.

16. The Surface Impression Removal Technology System of claim 15, wherein the first foam pad has a different density than the second foam pad.

17. The Surface Impression Removal Technology System of claim 15, wherein the first foam pad has a different ILD than the second foam pad.

18. The Surface Impression Removal Technology System of claim 15, wherein the first foam pad has a different thickness than the second foam pad.

19. A Surface Impression Removal Technology System comprising:
at least one visco-elastic memory foam pad having a density in the range of approximately 1.1 lb/f³ to 4.56 lb/f³, an ILD in the range of approximately 10 to 85 and a thickness in the range of approximately 1 to 2 inches;
wherein the at least one visco-elastic memory foam pad is placed atop of a mattress foundation and underneath a mattress; and
wherein the at least one visco-elastic memory foam pad has a length, width and thickness that are less than the length, width and thickness of the mattress.

20. The Surface Impression Removal Technology System of claim 19, wherein a first visco-elastic memory foam pad is positioned in a side-by-side with a second visco-elastic memory foam pad.

21. The Surface Impression Removal Technology System of claim 20, wherein the first visco-elastic memory foam pad has a different density than the second visco-elastic memory foam pad.

22. The Surface Impression Removal Technology System of claim 20, wherein the first visco-elastic memory foam pad has a different ILD than the second visco-elastic memory foam pad.

23. The Surface Impression Removal Technology System of claim 20, wherein the first visco-elastic memory foam pad has a different thickness than the second visco-elastic memory foam pad.

24. The Surface Impression Removal Technology System of claim 19, wherein a first visco-elastic memory foam pad is positioned in a head-to-toe arrangement with a second visco-elastic memory foam pad.

25. The Surface Impression Removal Technology System of claim 24, wherein the first visco-elastic memory foam pad has a different density than the second visco-elastic memory foam pad.

26. The Surface Impression Removal Technology System of claim 24, wherein the first visco-elastic memory foam pad has a different ILD than the second visco-elastic memory foam pad.

27. The Surface Impression Removal Technology System of claim 24, wherein the first visco-elastic memory foam pad has a different thickness than the second visco-elastic memory foam pad.

28. The Surface Impression Removal Technology System of claim 19, wherein a visco-elastic memory foam pad and a second visco-elastic memory foam pad are in a stacked positioned directly atop each other.
